(19) United States
(12) Patent Application Publication
(10) Pub. No.: US 2026/0162334 A1
(43) Pub. Date: Jun. 11, 2026

(54) METHOD, APPARATUS, DEVICE AND STORAGE MEDIUM FOR IMAGE EDITING

(71) Applicant: Beijing Zitiao Network Technology Co., Ltd., Beijing (CN)

(72) Inventors: Yang LIU, Beijing (CN); Mingxu DING, Beijing (CN); Cheng LI, Beijing (CN)

(21) Appl. No.: 19/320,325

(22) Filed: Sep. 5, 2025

(30) Foreign Application Priority Data
Dec. 6, 2024 (CN) 202411799232.8

(51) Int. Cl. G06T 11/60

(52) U.S. Cl. CPC G06T 11/60; G06T 2200/24

(57) ABSTRACT

Embodiments of the disclosure relate to a method, an apparatus, a device, and a storage medium for image editing. The method proposed herein includes: obtaining a first image to be edited, the first image including a target object; and presenting a second image and instruction description content associated with an editing prompt, the second image being generated based on the first image and the editing prompt, the editing prompt indicating at least one editing operation for the target object in the first image, and the editing prompt being generated at least based on the target object.

### CROSS-REFERENCE

The present application claims priority to Chinese Patent Application No. 202411799232.8, filed on Dec. 6, 2024, and entitled “METHOD, APPARATUS, DEVICE AND STORAGE MEDIUM FOR IMAGE EDITING”, which is incorporated herein by reference in its entirety.

### FIELD

Example embodiments of the present disclosure generally relate to the field of computers, and in particular, to a method, an apparatus, a device, and a computer-readable storage medium for image editing.

### BACKGROUND

With the development of computer technologies, artificial intelligence technologies are gradually applied to the generation of various types of media content. For example, some image editing models may support a user in inputting a prompt to adjust image content. However, such a prompt has a high creation threshold, which may make it difficult for ordinary users to obtain a desired editing result.

### SUMMARY

In a first aspect of the present disclosure, a method for image editing is provided. The method includes: obtaining a first image to be edited, the first image including a target object; and presenting a second image and instruction description content associated with an editing prompt, the second image being generated based on the first image and the editing prompt, the editing prompt indicating at least one editing operation for the target object in the first image, and the editing prompt being generated at least based on the target object.

In a second aspect of the present disclosure, an apparatus for image editing is provided. The apparatus includes: an obtaining module configured to obtain a first image to be edited, the first image including a target object; and a presentation module configured to present a second image and instruction description content associated with an editing prompt, the second image being generated based on the first image and the editing prompt, the editing prompt indicating at least one editing operation for the target object in the first image, and the editing prompt being generated at least based on the target object.

In a third aspect of the present disclosure, an electronic device is provided. The device includes at least one processor; and at least one memory, the at least one memory being coupled to the at least one processor and storing instructions executable by the at least one processor, the instructions, when executed by the at least one processor, causing the device to perform the method of the first aspect.

In a fourth aspect of the present disclosure, a computer-readable storage medium is provided. The computer-readable storage medium has a computer program stored thereon, the computer program being executable by a processor to implement the method of the first aspect.

It should be understood that content described in the Summary section is neither intended to identify key or essential features of embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of embodiments of the present disclosure will become more apparent in combination with the drawings and with reference to the following detailed description. In the drawings, the same or similar reference symbols refer to the same or similar elements, where:

FIG. 1 shows a schematic diagram of an example environment in which embodiments of the present disclosure may be implemented;

FIG. 2A to FIG. 2D show example interfaces for image editing according to some embodiments of the present disclosure;

FIG. 3 shows an example editing link according to some embodiments of the present disclosure;

FIG. 4 shows a flowchart of an example image editing process according to some embodiments of the present disclosure;

FIG. 5 shows a block diagram of an apparatus for image editing according to some embodiments of the present disclosure; and

FIG. 6 shows a block diagram of an electronic device capable of implementing multiple embodiments of the present disclosure.

### DETAILED DESCRIPTION

It may be understood that before the technical solutions disclosed in the embodiments of the present disclosure are used, the user shall be informed of the type, range of use, use scenarios, etc. of personal information involved in the present disclosure in an appropriate manner and the authorization of the user shall be obtained in accordance with relevant laws and regulations.

For example, in response to receiving an active request from a user, prompt information is sent to the user to clearly prompt the user that the requested operation will require access to and use of the user's personal information. In this way, the user may independently choose whether to provide the personal information to software or hardware, such as an electronic device, an application, a server, or a storage medium, that performs the operations of the technical solutions of the present disclosure based on the prompt information.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to select “agree” or “disagree” to provide the personal information to the electronic device.

It may be understood that the above process of notifying and obtaining user authorization is only illustrative and does not limit the implementations of the present disclosure, and other methods that satisfy relevant laws and regulations may also be applied to the implementations of the present disclosure.

It may be understood that the data involved in the technical solution (including but not limited to the data itself, acquisition or use of the data) shall comply with requirements of corresponding laws, regulations and related provisions.

As used herein, the term “in response to” refers to a state in which a corresponding event occurs or a condition is satisfied. It will be understood that an execution timing of a subsequent action performed in response to the event or condition is not necessarily strongly correlated with a time at which the event occurs or the condition is satisfied. For example, in some cases, the subsequent action may be performed immediately when the event occurs or the condition is satisfied; in other cases, the subsequent action may be performed after a period of time after the event occurs or the condition is satisfied.

Embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein; on the contrary, these embodiments are provided for a more thorough and complete understanding of the present disclosure. It should be understood that the drawings and embodiments of the present disclosure are only for illustrative purposes and are not intended to limit the protection scope of the present disclosure.

It should be noted that the titles of any section/sub-section provided herein are not restrictive. Various embodiments are described throughout this document, and any type of embodiments may be included under any section/sub-section. In addition, the embodiments described in any section/sub-section may be combined with any other embodiments described in the same section/sub-section and/or different section/sub-section in any manner.

In the description of embodiments of the present disclosure, the term “include/comprise” and similar terms thereto should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other definitions, either explicit or implicit, may also be included below. The terms “first”, “second”, etc. may refer to different or same objects. Other definitions, either explicit or implicit, may also be included below.

As briefly mentioned above, some image editing models may support a user in inputting a prompt to adjust image content. However, such a prompt has a high creation threshold, which may make it difficult for ordinary users to obtain a desired editing result.

In view of this, embodiments of the present disclosure provide a solution for image editing. The solution includes: obtaining a first image to be edited, the first image including a target object; and presenting a second image and instruction description content associated with an editing prompt, the second image being generated based on the first image and the editing prompt, the editing prompt indicating at least one editing operation for the target object in the first image, and the editing prompt being generated at least based on the target object.

In this way, embodiments of the present disclosure are capable of automatically generating a matching editing prompt based on an object in an image to be edited, and providing an editing result obtained based on the editing prompt. On the one hand, the embodiments of the present disclosure may reduce the learning cost and interaction cost of the user; on the other hand, embodiments of the present disclosure may also improve the quality of the editing prompt, thereby the quality of the generated image editing result is improved.

The example embodiments of the present disclosure are described below with reference to the drawings.

### Example Environment

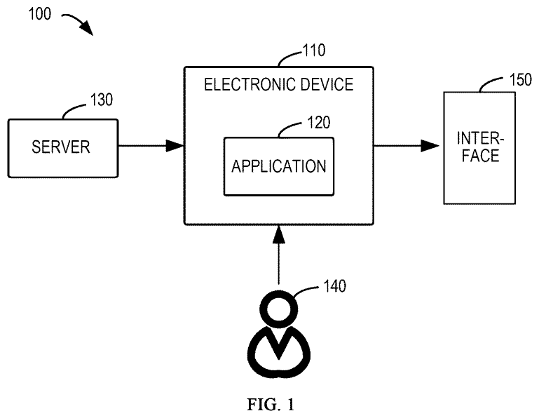

FIG. 1 shows a schematic diagram of an example environment 100 in which the embodiments of the present disclosure may be implemented. As shown in FIG. 1, the example environment 100 may include an electronic device 110.

In the example environment 100, an application 120 for image editing may be run on the electronic device 110. The application 120 may be any suitable type of application for editing media content, examples of which may include, but are not limited to, a media editing application, a content sharing application, and the like. A user 140 may interact with the application 120 via the electronic device 110 and/or its attached devices.

In the environment 100 of FIG. 1, if the application 120 is active, the electronic device 110 may present an interface 150 corresponding to the application 120. The interface 150 may include various types of pages provided by the application 120, such as an editing page for media content. For example, a media editing application may display media content to be edited and a plurality of controls for editing, and the user 140 may select a corresponding control to edit the media content.

In some embodiments, the electronic device 110 communicates with a server 130 to implement the provision of services for the application 120. The server 130 may provide functions such as management, configuration, and maintenance of the application or website, and recognition of a target object in image content.

The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a Personal Communication System (PCS) device, a personal navigation device, a Personal Digital Assistant (PDA), an audio/video player, a digital camera/video camera, a positioning device, a television receiver, a radio broadcast receiver, an e-book device, a game device, or any combination of the foregoing, including accessories and peripherals of these devices or any combination thereof. In some embodiments, the electronic device 110 may also support any type of user-specific interface (such as “wearable” circuitry, etc.).

The server 130 may be an independent physical server, a server cluster or distributed system composed of a plurality of physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 130 may include, for example, a computing system/server, such as a mainframe, an edge computing node, a computing device in a cloud environment, and so on. The server 130 may provide backstage services for the application 120 supporting a virtual scene in the electronic device 110.

A communication connection may be established between the server 130 and the electronic device 110. The communication connection may be established in a wired or wireless manner. The communication connection may include, but is not limited to, a Bluetooth connection, a mobile network connection, a Universal Serial Bus (USB) connection, a Wireless Fidelity (WiFi) connection, etc., and the embodiments of the present disclosure are not limited in this regard. In the embodiments of the present disclosure, the server 130 and the electronic device 110 may implement signaling interaction through the communication connection therebetween.

It should be understood that the structure and function of each element in the environment 100 are described for illustrative purposes only, without suggesting any limitation on the scope of the present disclosure.

Various example implementations of the present disclosure are described in detail below.

### Example Interaction

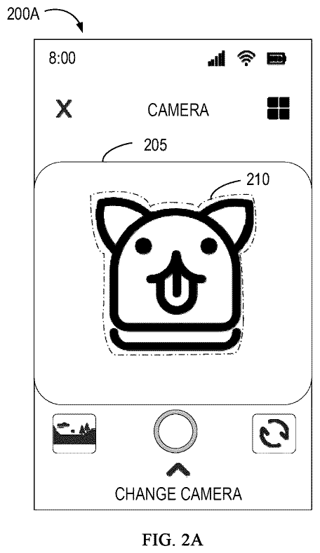

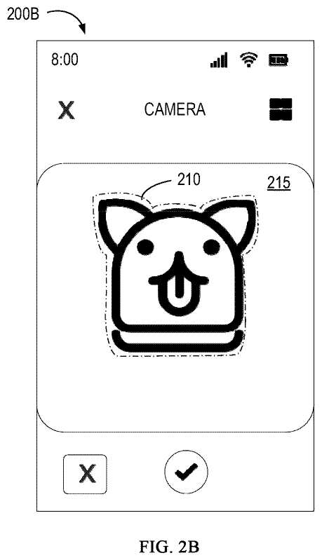

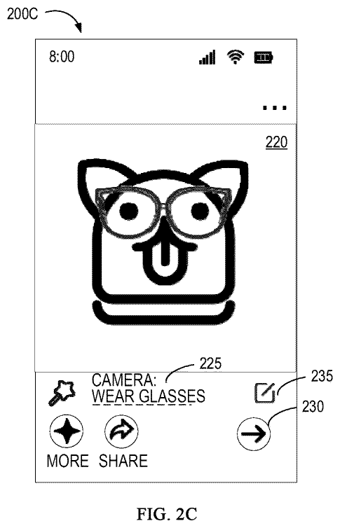

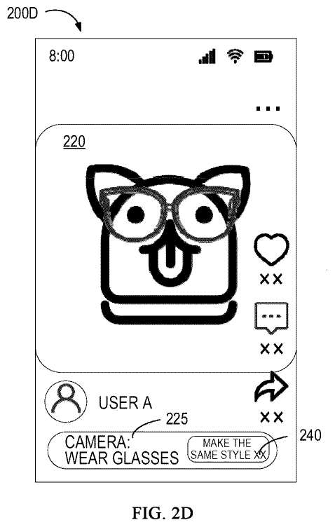

The example editing interfaces 200A to 200D according to some embodiments of the present disclosure are described below with reference to FIGS. 2A to 2D. The interfaces 200A to 200D may be provided by, for example, the electronic device 110 shown in FIG. 1.

As an example, FIG. 2A shows a framing interface 200A of a camera. For example, the framing interface 200A may include a viewfinder 205 for presenting a real-time image captured by the camera of the electronic device 110.

In addition, the electronic device 110 may present a marking element 210 in the viewfinder 205, and the marking element 210 may be used to indicate a contour of an object to be edited in the image. As will be described in detail below, the electronic device 110 may, for example, trigger a specific editing operation to be performed on a main object in the image to be edited.

As an example, the electronic device 110 and/or the server 130 may recognize the real-time image captured by the camera to determine a candidate editing object in the real-time image, such as the dog shown in FIG. 2A. Further, the electronic device 110 may present the marking element 210 based on contour information of the candidate editing object. As an example, the electronic device 110 may display, in the viewfinder 205, the marking element 210 (e.g., a contour line) that changes in real time with the movement of the dog.

Thus, embodiments of the present disclosure may enable the user to more intuitively perceive the region to be edited in the image.

Further, the electronic device 110 may receive a capturing instruction from the user. For example, the electronic device 110 may receive a click from the user on a capturing control. Accordingly, as shown in FIG. 2B, the electronic device 110 may obtain a first image 215 captured by the camera.

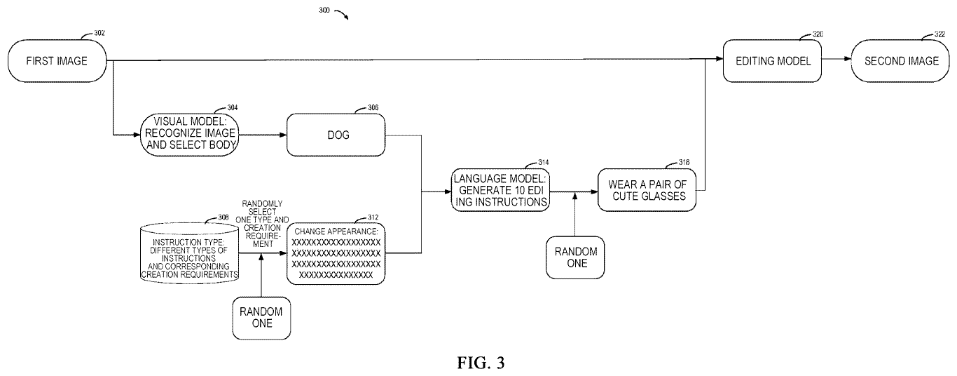

Further, the electronic device 110 may trigger a preset editing instruction to be automatically applied to the first image 215 to generate a second image 220 as shown in FIG. 2C. The specific generation process of the second image 220 will be described in detail below with reference to FIG. 3.

In some embodiments, the second image 220 may be generated by applying one or more editing operations to the target object in the first image 215. For example, the second image 220 may be obtained by applying an editing operation of “wearing glasses” for the “dog” in the first image 215.

It should be understood that the target object to be edited in the first image 215 may be associated with, but not required to fully correspond to, the marking element 210. For example, an entity recognition model for determining the marking element 210 and an entity recognition model for determining the target object may be different models.

Additionally or alternatively, the electronic device 110 may also receive an editing operation from the user to determine the target object to be edited. For example, the electronic device 110 may receive an adjustment operation from the user on the marking element 210 to indicate the target object to be edited. Accordingly, the entity recognition model may extract the target object based on the adjusted marking element 210, for example.

In some embodiments, the second image 220 may be generated, for example, by an editing model processing the first image 215 based on an editing prompt. As will be described in detail below, the editing prompt may be automatically generated based on the target object (such as the dog) recognized in the first image 215, without manual operation by the user.

For example, the editing prompt may be a prompt that matches a type of the target object. For example, if the target object is a dog, it is suitable for the editing operation of “wearing glasses”. On the contrary, if the target object is food or the like, the editing operation of “wearing glasses” is not applicable.

In some embodiments, in order to facilitate understanding of the editing operation performed on the first image 215, the electronic device 110 may also present instruction description content 225 associated with the editing prompt in the interface 200C. The instruction description content 225 may indicate, for example, the applied editing operation, such as “wearing glasses”.

It should be understood that the editing prompt refers to indication information provided to the editing model, which, for example, has richer expressions. The instruction description content 225 may have, for example, a relatively concise expression to indicate the editing operation corresponding to the editing prompt.

In some embodiments, the electronic device 110 may also support re-editing the image. Specifically, the electronic device 110 may receive a re-generation request from the user. For example, the electronic device 110 may receive the selection of a re-applying control of the user, and may trigger an image generated based on the first image and a new editing prompt.

As an example, the new editing prompt may be, for example, a re-generated prompt, and it may be different from the editing prompt used previously. In addition, the new editing prompt may also correspond to different editing types, for example. For example, the original editing prompt may correspond to the operation of “wearing glasses”. After receiving the re-generation request, the model may determine a new editing prompt that matches the “dog” object, such as “tilting the head”.

In some embodiments, the electronic device 110 may also click the modification control 235, for example, to modify the instruction description content 225. Further, the electronic device 110 may trigger the re-generation request associated with the modified instruction description content 225. Accordingly, the model may determine a new editing prompt based on the modified instruction description content 225 to generate a new image.

As an example, the user may modify the instruction description content 225 to “wearing glasses, tilting the head”. Accordingly, the model may generate a new editing prompt based on the modified instruction description content 225, and may trigger the generation of a new image, so that the “dog” object presents both the effects of “wearing glasses” and “tilting the head”.

In some embodiments, in addition to the editing operation applied to the target object (such as the dog) in the first image 215, the editing prompt may also support, for example, an editing operation applied to other regions of the first image 215. For example, the editing prompt may correspond to, for example, “wearing glasses, grassland”, and the generated second image 220 may update the background region to grassland, for example.

In some embodiments, the editing operation applied to the background region may be determined based on the first image 215 or the target object (such as the dog), so that such an editing operation may be adapted to the image content.

As shown in FIG. 2C, the electronic device 110 may also provide a posting control 230, for example. Further, the electronic device 110 may receive a click on the posting control 230 to receive a request to post the second image 220.

As shown in FIG. 2D, after the second image 220 is posted, the electronic device 110 corresponding to any appropriate user may present a viewing interface 200D of the posted second image 220.

As shown in the figure, the electronic device 110 may present the posted second image 220 and the corresponding instruction description content 225 in the interface 200D. In addition, the electronic device 110 may also provide a creation entry 240.

As an example, the second image 220 may be posted by “user A”, for example. Accordingly, another user B may initiate a new image editing request by clicking the creation entry 240 in the interface 200D.

Specifically, the electronic device 110 corresponding to user B may receive an image captured or uploaded by user B. Further, the electronic device 110 may trigger the editing prompt corresponding to the second image to be applied to the image of user B, thereby a new image is generated.

As an example, the image uploaded by user B may be an image with a cat. Further, the editing prompt corresponding to the second image may instruct to wear glasses for the main object in the figure. Accordingly, the image editing result obtained by user B may be a cat image wearing glasses.

In some embodiments, the electronic device 110 may also support user B to trigger the re-generation request, for example. Similar to the process discussed above with reference to FIG. 2C, user B may modify the instruction description content, for example, to trigger a new editing prompt to be generated based on the modified instruction description content, so as to generate a new editing result.

In this way, the embodiments of the present disclosure may support other users to reuse the editing prompt to apply a similar editing effect, thereby improving the efficiency of image editing.

### Example Editing Link

The example process of image editing according to the embodiments of the present disclosure is described below with reference to FIG. 3. FIG. 3 shows an example editing link 300 according to some embodiments of the present disclosure.

As shown in FIG. 3, the server 130 may obtain a first image 302. Although the example of capturing the first image by shooting is described above by taking camera shooting as an example, the first image may also include, for example, an image uploaded or specified by the user.

Further, the server 130 may use a visual model 304 to recognize the image of the first image and determine the main object in the first image. Taking the first image 215 shown in FIG. 2B as an example, the visual model may recognize that the main object 306 of the first image 215 is a “dog”, for example.

In some embodiments, the server 130 may also determine at least one editing type to be applied. As shown in FIG. 3, the server 130 may determine at least one editing type 312 from a set of preset editing types 308.

As an example, the set of preset editing types 308 may include various types of editing instructions, such as change instructions (e.g., changing appearance), addition instructions (e.g., adding new elements), and the like.

In some embodiments, the electronic device 110 may randomly determine one or more editing types 312 to be applied from the set of preset editing types 308, for example.

In some embodiments, the electronic device 110 may further determine at least one editing type 312 from the set of preset editing types 308 based on the target object 306 recognized in the first image 302, for example.

Further, the server 130 may use a language model 314 to generate one or more editing prompts (also referred to as editing instructions) based on the target object 306 and the at least one editing type 312.

As an example, the server 130 may provide first description information corresponding to the target object 306 and second description information corresponding to the at least one editing type 312 to the language model. As an example, the first description information may describe one or more attributes of the target object 306, such as a category attribute, an appearance attribute, and the like.

As another example, the second description information may indicate the editing type to be applied and the corresponding creation requirement. In some embodiments, such a creation requirement may be associated with the object to be applied, for example. For example, taking “changing appearance” as an example, such a creation requirement may indicate that the mouth area of the animal object may not be changed.

Accordingly, the language model 314 may generate one or more editing prompts that match the creation requirement based on the received first description information and the received second description information.

As an example, the server 130 may randomly determine an editing prompt 318 to be applied from the one or more editing prompts 314. As an example, the editing prompt 318 may be “wearing a pair of cute glasses”.

Further, the editing model 320 may obtain the editing prompt 318 and the first image 302 to perform controllable editing on the first image 302 to generate a second image 322. For example, the second image 322 may be obtained by applying the editing operation of “wearing glasses” to the dog object in the first image 302.

In some embodiments, in order to improve the quality of the image, the server 130 may also correct the editing result generated by the editing model 320 to generate the second image 322, for example.

Specifically, the server 130 may use the editing model 320 to process the first image 302 based on the editing prompt 318 to generate an intermediate image. Further, the server 130 may also determine change information associated with a preset object in the first image based on the editing prompt 318, for example.

As an example, such a preset object may include a face object. The server 130 may provide the editing prompt 318 to the language model, for example, to determine the change information associated with the face object. Such change information may indicate, for example, a change degree and/or an occlusion degree of the preset object.

For example, the server 130 may use the language model to determine the degree of occlusion that “wearing a pair of cute glasses” may cause to the face object in the image. For example, the server 130 may determine that “wearing a pair of cute glasses” may cause obvious changes to the face object. In this case, the server 130 may determine, for example, that there is no need to update the intermediate image with the first image, and may output the intermediate image as the second image.

On the contrary, if the language model determines that the editing prompt 318 has a small degree of occlusion on the face object, the server 130 may use the first image 302 to update the generated intermediate image. For example, the server 130 may use the face area in the first image to update the corresponding content of the intermediate image, thereby maintaining the consistency of the face object.

In some embodiments, in the case where the occlusion degree is relatively small, the server 130 may further determine the corresponding update mode based on the change mode of the face object. For example, in the case where the contour of the face object changes greatly, the server 130 may use the first update algorithm; on the contrary, in the case where the contour of the face object changes little, the server 130 may use a different second update algorithm.

Based on this approach, the embodiments of the present disclosure are capable of automatically generating a matching editing prompt based on an object in an image to be edited, and providing an editing result obtained based on the editing prompt. On the one hand, the embodiments of the present disclosure may reduce the learning cost and interaction cost of the user; on the other hand, the embodiments of the present disclosure may also improve the quality of the editing prompt, thereby improving the quality of the generated image editing result.

### Example Process

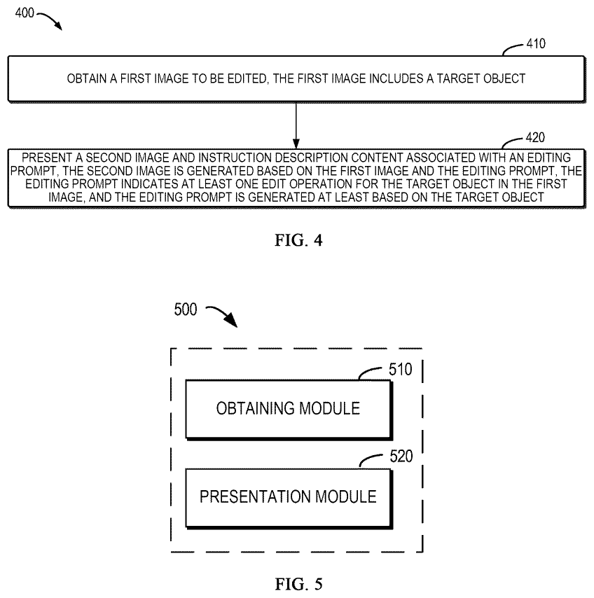

The example process of image editing according to embodiments of the present disclosure is described below with reference to FIG. 4. FIG. 4 shows a flowchart of an example process 400 of image editing. The process may be implemented at the electronic device 110. The process 400 will be described below with reference to FIG. 1.

As shown in FIG. 4, at block 410, the electronic device 110 obtains a first image to be edited, the first image includes a target object.

At block 420, the electronic device 110 presents a second image and instruction description content associated with an editing prompt, the second image is generated based on the first image and the editing prompt, the editing prompt indicates at least one editing operation for the target object in the first image, and the editing prompt is generated at least based on the target object.

In some embodiments, obtaining the first image to be edited includes: presenting a framing interface of a camera; and obtaining the first image captured by the camera in response to receiving a capturing instruction.

In some embodiments, the process 400 further includes: presenting a marking element associated with the target object in the framing interface.

In some embodiments, presenting the marking element associated with the target object includes: determining a candidate editing object in an image presented in the framing interface; and presenting the marking element to represent a contour of the candidate editing object.

In some embodiments, the editing prompt is determined based on the following process: determining the target object in the first image; determining at least one editing type to be applied; and generating, based on the target object, the editing prompt corresponding to the at least one editing type.

In some embodiments, determining the at least one editing type to be applied includes: determining the at least one editing type from a set of preset editing types based on the first image and/or the target object.

In some embodiments, generating, based on the target object, the editing prompt corresponding to the at least one editing type includes: providing first description information corresponding to the target object and second description information corresponding to the at least one editing type to a language model; and obtaining the editing prompt generated by the language model.

In some embodiments, the second image is generated based on the following process: processing the first image by using an editing model based on the editing prompt to generate an intermediate image; determining, based on the editing prompt, change information associated with a preset object in the first image; and updating, in response to the change information satisfying a preset condition, the intermediate image by using the first image to generate the second image.

In some embodiments, determining, based on the editing prompt, the change information associated with the preset object in the first image includes: providing the editing prompt to a language model to determine the change information associated with the preset object.

In some embodiments, the change information indicates a change degree and/or an occlusion degree of the preset object.

In some embodiments, the editing prompt is a first editing prompt, and the process 400 further includes: providing, in response to receiving a re-generation request, a third image generated based on the first image and a second editing prompt.

In some embodiments, the process 400 further includes: receiving a modification operation from a user for the instruction description text; and obtaining the re-generation request associated with modified instruction description text, where the second editing prompt is determined based on the modified instruction description text.

In some embodiments, the process 400 further includes: receiving a request to post the second image; and presenting, in a viewing interface of the second image, the second image and the instruction description content.

In some embodiments, the first image is associated with a first user, the viewing interface further includes a generation entry, and the generation entry is configured to obtain a fourth image associated with a second user to trigger generating a fifth image based on the editing prompt and the fourth image.

In some embodiments, the editing prompt further indicates an additional editing operation independent of the target object.

### Example Apparatus and Device

Embodiments of the present disclosure further provide a corresponding apparatus for implementing the above method or process. FIG. 5 shows a schematic structural block diagram of an apparatus 500 for image editing according to some embodiments of the present disclosure. The apparatus 500 may be implemented as or included in an appropriate electronic device 110. Each module/component in the apparatus 500 may be implemented by hardware, software, firmware, or any combination thereof.

As shown in FIG. 5, the apparatus 500 includes an obtaining module 510 configured to obtain a first image to be edited, the first image includes a target object; and a presentation module 520 configured to present a second image and instruction description content associated with an editing prompt, the second image being generated based on the first image and the editing prompt, the editing prompt indicating at least one editing operation for the target object in the first image, and the editing prompt being generated at least based on the target object.

In some embodiments, the obtaining module 510 is further configured to present a framing interface of a camera; and obtain the first image captured by the camera in response to receiving a capturing instruction.

In some embodiments, the apparatus 500 further includes an element presentation module configured to present a marking element associated with the target object in the framing interface.

In some embodiments, the presentation module 520 is further configured to determine a candidate editing object in an image presented in the framing interface; and present the marking element to represent a contour of the candidate editing object.

In some embodiments, the editing prompt is determined based on the following process: determining the target object in the first image; determining at least one editing type to be applied; and generating, based on the target object, the editing prompt corresponding to the at least one editing type.

In some embodiments, determining the at least one editing type to be applied includes: determining the at least one editing type from a set of preset editing types based on the first image and/or the target object.

In some embodiments, generating, based on the target object, the editing prompt corresponding to the at least one editing type includes: providing first description information corresponding to the target object and second description information corresponding to the at least one editing type to a language model; and obtaining the editing prompt generated by the language model.

In some embodiments, the second image is generated based on the following process: processing the first image by using an editing model based on the editing prompt to generate an intermediate image; determining, based on the editing prompt, change information associated with a preset object in the first image; and updating, in response to the change information satisfying a preset condition, the intermediate image by using the first image to generate the second image.

In some embodiments, determining, based on the editing prompt, the change information associated with the preset object in the first image includes: providing the editing prompt to a language model to determine the change information associated with the preset object.

In some embodiments, the change information indicates a change degree and/or an occlusion degree of the preset object.

In some embodiments, the editing prompt is a first editing prompt, and the apparatus 500 further includes a provision module configured to provide, in response to receiving a re-generation request, a third image generated based on the first image and a second editing prompt.

In some embodiments, the apparatus 500 further includes a first receiving module configured to receive a modification operation from a user for the instruction description text; and a request obtaining module configured to obtain the re-generation request associated with modified instruction description text, where the second editing prompt is determined based on the modified instruction description text.

In some embodiments, the apparatus 500 further includes a second receiving module configured to receive a request to post the second image; and a content presentation module configured to present, in a viewing interface of the second image, the second image and the instruction description content.

In some embodiments, the first image is associated with a first user, the viewing interface further includes a generation entry, where the generation entry is configured to obtain a fourth image associated with a second user to trigger generating a fifth image based on the editing prompt and the fourth image.

In some embodiments, the editing prompt further indicates an additional editing operation independent of the target object.

The units included in the apparatus 500 may be implemented in various ways, including software, hardware, firmware, or any combination thereof. In some embodiments, one or more units may be implemented using software and/or firmware, such as machine-executable instructions stored on a storage medium. In addition to machine-executable instructions or as an alternative, some or all units in the apparatus 500 may be implemented at least partially by one or more hardware logic components. As an example, rather than a limitation, example types of hardware logic components that may be used include Field Programmable Gate Array (FPGA), Application Specific Integrated Circuit (ASIC), Application Specific Standard (ASSP), System on Chip (SOC), Complex Programmable Logic Device (CPLD), and so on.

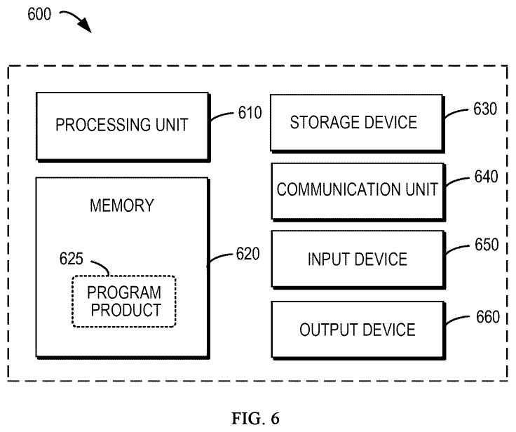

FIG. 6 shows a block diagram of an electronic device 600 in which one or more embodiments of the present disclosure may be implemented. It should be understood that the electronic device 600 shown in FIG. 6 is only illustrative and should not constitute any limitation on the functionality and scope of the embodiments described herein. The electronic device 600 shown in FIG. 6 may be used to implement the electronic device 110 in FIG. 1.

As shown in FIG. 6, the electronic device 600 is in the form of a general-purpose electronic device. The components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and may execute various processes based on the programs stored in the memory 620. In a multi-processor system, a plurality of processing units executes computer-executable instructions in parallel to improve the parallel processing capability of the electronic device 600.

The electronic device 600 typically includes a plurality of computer storage medium. Such medium may be any available medium that is accessible to the electronic device 600, including, but not limited to, volatile and non-volatile medium, removable and non-removable medium. The memory 620 may be volatile memory (for example, a register, cache, Random Access Memory (RAM)), a non-volatile memory (such as a Read-Only Memory (ROM), Electrically Erasable Programmable Read-Only Memory (EEPROM), a flash memory), or any combination thereof. The storage device 630 may be a removable or non-removable medium, and may include a machine-readable medium such as a flash drive, a disk, or any other medium, which may be used to store information and/or data and may be accessed within the electronic device 600.

The electronic device 600 may further include additional removable/non-removable, volatile/non-volatile memory medium. Although not shown in FIG. 6, it is possible to provide a disk driver for reading from or writing to a removable, non-volatile disk (such as a “floppy disk”), and an optical disk driver for reading from or writing to a removable, non-volatile optical disk. In these cases, each driver may be connected to the bus (not shown) by one or more data medium interfaces. The memory 620 may include a computer program product 625, which has one or more program modules configured to perform various methods or acts of the various embodiments of the present disclosure.

The communication unit 640 enables communication with other electronic devices through the communication medium. Additionally, the functions of the components of the electronic device 600 may be implemented by a single computing cluster or a plurality of computing machines, which may communicate through a communication connection. Therefore, the electronic device 600 may use a logical connection with one or more other servers, a network personal computer (PC) or another network node to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) such as a storage device, a display device, etc., with one or more devices that enable the user to interact with the electronic device 600, or with any devices (such as a network card, a modem, etc.) that enable the electronic device 600 to communicate with one or more other electronic devices via the communication unit 640 as needed. Such communication may be performed via input/output (I/O) interfaces (not shown).

According to an illustrative implementation of the present disclosure, there is provided a computer-readable storage medium having computer-executable instructions stored thereon, where the computer-executable instructions are executed by a processor to implement the method described above. According to an illustrative implementation of the present disclosure, there is further provided a computer program product tangibly stored on a non-transitory computer-readable medium and including computer-executable instructions, which are executed by a processor to implement the method described above.

Various aspects of the present disclosure are described herein with reference to flowcharts and/or block diagrams of methods, apparatuses, devices, and computer program products implemented according to the present disclosure. It should be understood that each block of the flowchart and/or block diagram, and combinations of blocks in the flowchart and/or block diagram, may be implemented by computer-readable program instructions.

These computer-readable program instructions may be provided to a processing unit of a general-purpose computer, a special-purpose computer, or other programmable data processing apparatus to produce a machine, such that the instructions, when executed by the processing unit of the computer or other programmable data processing apparatus, create means for implementing the functions/acts specified in one or more blocks of the flowchart and/or block diagram. These computer-readable program instructions may also be stored in a computer-readable storage medium, these instructions cause a computer, a programmable data processing apparatus, and/or other devices to work in a particular manner, and thus, the computer-readable medium storing the instructions includes an article of manufacture, which includes instructions for implementing various aspects of the functions/acts specified in one or more blocks of the flowchart and/or block diagram.

The computer-readable program instructions may be loaded onto a computer, another programmable data processing apparatus, or other devices, causing a series of operating steps to be performed on the computer, another programmable data processing apparatus, or other devices to produce a computer-implemented process, such that the instructions executed on the computer, another programmable data processing apparatus, or other devices implement the functions/acts specified in one or more blocks of the flowchart and/or block diagram.

The flowchart and block diagram in the drawings show the possibly implemented architectures, functions, and operations of the system, method, and computer program product according to a plurality of implementations of the present disclosure. In this regard, each block in the flowchart or block diagram may represent a module, program segment, or part of an instruction, which includes one or more executable instructions for implementing the specified logical function. In some alternative implementations, the functions marked in the block may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a special-purpose hardware-based system that performs the specified functions or acts, or may be implemented by a combination of special-purpose hardware and computer instructions.

The implementations of the present disclosure have been described above, and the above description is illustrative, non-exhaustive, and not limited to the disclosed implementations. Many modifications and variations will be apparent to those of ordinary skill in the art without departing from the scope and spirit of the described implementations. The terms used herein are chosen to best explain the principles of the implementations, the practical applications or improvements to the technology in the market, or to enable other ordinary skilled persons in the art to understand the implementations disclosed herein.

1. A method for image editing, comprising:
obtaining a first image to be edited, the first image comprising a target object; and
presenting a second image and instruction description content associated with an editing prompt, the second image being generated based on the first image and the editing prompt, the editing prompt indicating at least one editing operation for the target object in the first image, and the editing prompt being generated at least based on the target object.

2. The method of claim 1, wherein obtaining the first image to be edited comprises:
presenting a framing interface of a camera; and
obtaining the first image captured by the camera in response to receiving a capturing instruction.

3. The method of claim 2, further comprising:
presenting a marking element associated with the target object in the framing interface.

4. The method of claim 3, wherein presenting the marking element associated with the target object comprises:
determining a candidate editing object in an image presented in the framing interface; and
presenting the marking element to represent a contour of the candidate editing object.

5. The method of claim 1, wherein the editing prompt is determined based on the following process:
determining the target object in the first image;
determining at least one editing type to be applied; and
generating, based on the target object, the editing prompt corresponding to the at least one editing type.

6. The method of claim 5, wherein determining the at least one editing type to be applied comprises:
determining the at least one editing type from a set of preset editing types based on the first image and/or the target object.

7. The method of claim 5, wherein generating, based on the target object, the editing prompt corresponding to the at least one editing type comprises:
providing first description information corresponding to the target object and second description information corresponding to the at least one editing type to a language model; and
obtaining the editing prompt generated by the language model.

8. The method of claim 1, wherein the second image is generated based on the following process:
processing the first image by using an editing model based on the editing prompt to generate an intermediate image;
determining, based on the editing prompt, change information associated with a preset object in the first image; and
updating, in response to the change information satisfying a preset condition, the intermediate image by using the first image to generate the second image.

9. The method of claim 8, wherein determining, based on the editing prompt, the change information associated with the preset object in the first image comprises:
providing the editing prompt to a language model to determine the change information associated with the preset object.

10. The method of claim 8, wherein the change information indicates a change degree and/or an occlusion degree of the preset object.

11. The method of claim 1, wherein the editing prompt is a first editing prompt, and the method further comprises:
providing, in response to receiving a re-generation request, a third image generated based on the first image and a second editing prompt.

12. The method of claim 11, further comprising:
receiving a modification operation from a user for the instruction description text; and
obtaining the re-generation request associated with modified instruction description text, wherein the second editing prompt is determined based on the modified instruction description text.

13. The method of claim 1, further comprising:
receiving a request to post the second image; and
presenting, in a viewing interface of the second image, the second image and the instruction description content.

14. The method of claim 13, wherein the first image is associated with a first user, the viewing interface further comprises a generation entry,
wherein the generation entry is configured to obtain a fourth image associated with a second user to trigger generating a fifth image based on the editing prompt and the fourth image.

15. The method of claim 1, wherein the editing prompt further indicates an additional editing operation independent of the target object.

16. An electronic device, comprising:
at least one processor; and
at least one memory, the at least one memory being coupled to the at least one processor and storing instructions executable by the at least one processor, the instructions, when executed by the at least one processor, causing the electronic device to perform acts comprising:
obtaining a first image to be edited, the first image comprising a target object; and
presenting a second image and instruction description content associated with an editing prompt, the second image being generated based on the first image and the editing prompt, the editing prompt indicating at least one editing operation for the target object in the first image, and the editing prompt being generated at least based on the target object.

17. The electronic device of claim 16, wherein obtaining the first image to be edited comprises:
presenting a framing interface of a camera; and
obtaining the first image captured by the camera in response to receiving a capturing instruction.

18. The electronic device of claim 17, wherein the acts further comprise:
presenting a marking element associated with the target object in the framing interface.

19. The electronic device of claim 18, wherein presenting the marking element associated with the target object comprises:
determining a candidate editing object in an image presented in the framing interface; and
presenting the marking element to represent a contour of the candidate editing object.

20. A non-transitory computer-readable storage medium having a computer program stored thereon, the computer program, when executed by a processor, implementing acts comprising:
obtaining a first image to be edited, the first image comprising a target object; and
presenting a second image and instruction description content associated with an editing prompt, the second image being generated based on the first image and the editing prompt, the editing prompt indicating at least one editing operation for the target object in the first image, and the editing prompt being generated at least based on the target object.
